(19) United States
(12) Patent Application Publication
(10) Pub. No.: US 2026/0014611 A1
(43) Pub. Date: Jan. 15, 2026

(54) METHOD OF MANUFACTURE OF A REINFORCED PIPE

(71) Applicant: Odfjell Oceanwind AS, Kokstad (NO)

(72) Inventors: Eystein BORGEN, Rådal (NO); Håkon KLEPSVIK, Paradis (NO)

(21) Appl. No.: 18/995,555

(22) PCT Filed: Jul. 6, 2023
(86) PCT No.: PCT/EP2023/068744

§ 371 Date: Jan. 16, 2025

(30) Foreign Application Priority Data
Jul. 26, 2022 (NO) 20220832

(51) Int. Cl. B21D 11/06; B21D 5/14; F16L 9/16

(52) U.S. Cl. CPC B21D 11/06; B21D 5/14; F16L 9/165

(57) ABSTRACT

A method of manufacture for a reinforced pipe (10), including the steps of, providing a first metal plate (1), having a thickness t; bending the first metal plate (1) along a bending line to form a helix (30), wherein the pitch of the helix (30) is substantially equal to the width of the plate; and wherein two consecutive turns of the helix (30) are in contact at a seam (20); welding the helix along the seam (20) forming a pipe; and welding at least a first metal stiffening element (2) to the pipe, forming a reinforced pipe (10).

### FIELD OF THE INVENTION

The present invention relates a to method of manufacture of a reinforced pipe.

### BACKGROUND

The offshore floating wind industry is growing. New wind turbines designs are being developed with increasing size. Thus, new buoyancy tanks that are both light weight and strong have to be provided in an efficient manner in order to produce floating structures having enough buoyancy at a lowest possible cost.

The present invention relates to cylinder fabrication methods, more particularly to methods for fabricating ring stiffened cylinders which may be used as buoyancy members of an offshore floating wind turbine structure or other large diameter thin shell structure. One solution so far has been to reduce the wall thickness to reduce the steel weight and thereby the costs of floating offshore structures.

Conventional techniques for fabrication of ring stiffened structures comprise bending a metal plate to form a structure, such as a pipe, and thereafter welding ring elements on the inside of the pipe. For structures, such as pipes, with relatively large diameter to wall thickness ratios, this method has been fraught with problems pertaining to buckling during the bending of the metal plate due to the plate's own weight. This is also the case if spiral welding of the pipe using conventional techniques is used as fabrication method. It is also expensive to weld in the ring stiffening elements after the plate has been bent as this will pose an extra operation including extra handling during the manufacturing of the stiffened shells. One solution to this has been to design for flat plates buoyancy members instead of circular cylinders. Flat plated structures can easily be stiffened with T-beams by welding the T-beams to the hull plate when the plate is in the flat position on the floor. This is a well-known manufacturing method in the shipbuilding industry. Flat plated stiffened panels are therefore less costly to produce per kg steel than circular stiffened panels. However, flat panel buoyancy members will have higher hydrodynamic excitation forces and thus more steel is needed for the same wind turbine carrying floating foundation.

Therefore, new methods of production have been developed in order to alleviate the problems of the existing methods for fabrication of stiffened thin-walled shells.

### SUMMARY OF THE INVENTION

The present invention is defined by the appended claims and in the following:

In a first aspect, the invention relates to a method of manufacture for a reinforced pipe including the steps of,
a) providing a first metal plate, having a thickness t,
b) bending the first metal plate along a bending line to form a helix,
   wherein the pitch of the helix is substantially equal to the width of the plate, and
   wherein two consecutive turns of the helix are in contact at a seam;
c) welding the helix along the seam forming a pipe; and
d) welding at least a first metal stiffening element to the pipe, forming a reinforced pipe.

The skilled person will understand that the bending is realized by using any bending machine known in the art. All the production steps may advantageously be achieved without the need to remove the plate, pipe or reinforced pipe from the bending machine.

The skilled person will understand that the term “substantially equal to” here means “equal to with a 10% margin”. In other words, the pitch of the helix is comprised between 90% and 110% of the width of the plate.

In an embodiment, the pitch of the helix is comprised between 95% and 105%, 90% and 110%, 100% and 110%, 100% and 105%, 95% and 100%, 100% and 102%, or 100% and 101% of the width of the plate.

In an embodiment of the method, the reinforced pipe has a diameter D, and the ratio D/t may be at least 100, at least 150, at least 200, at least 250, at least 300 or at least 500.

In an embodiment, the ratio D/t may be comprised between 100 and 1500; preferably between 200 and 800.

In an embodiment, in step c), the helix is welded along the seam within 400° of the bending line, i.e. the line on the metal plate along which the metal plate is bent; and an angle α is defined between a first radius of the helix along which the metal plate is bent starting from the bending line, and a second radius of the helix starting from the welding point.

In an embodiment, in step c), the helix is welded along the seam within 360°, within 270°, within 180°, within 135°, within 90°, within 60°, within 45°, within 30°, within 10° or within 5° of the bending line

In an embodiment, in step d), the at least a first metal stiffening element is welded within 400° of the bending line; i.e. the line on the metal plate along which the metal plate is bent; and an angle β is defined between a first radius of the helix along which the metal plate is bent starting from the bending line, and a second radius of the helix starting from the welding point.

In an embodiment, in step d), the at least a first metal stiffening element is welded within 360°, within 270°, within 180°, within 135°, within 90°, within 60°, within 45°, within 30°, within 10° or within 5° of the bending line

In an embodiment, the at least a first metal stiffening element to the pipe is not bent with the first metal plate.

In an embodiment, the at least a first metal stiffening element to the pipe is bent with the first metal plate.

In an embodiment, the thickness t may be 50 mm or less, 40 mm or less, 30 mm or less, 25 mm or less, 20 mm or less, 15 mm or less, or 10 mm or less.

In an embodiment, the thickness t may be comprised between 10 mm and 500 mm, preferably between 15 mm and 200 mm.

In an embodiment, the diameter D may be comprised between 5 m and 50 m; preferably between 8 m and 30 m.

In an embodiment width of the metal plate is 10 times, 20 times, 50 times, 100 times, 500 times, 1000 times the width of the first metal stiffening element.

In an embodiment, the welding step d) may comprise welding at least two, at least three, at least four, at least five or at least ten first metal stiffening elements on the first metal plate.

In an embodiment the welding step d) may comprise welding at least two first metal stiffening elements on the first metal plate and the at least two first metal stiffening elements are parallel to each other.

In an embodiment, the at least two first metal stiffening elements are parallel, and the distance between the at least two first metal stiffening elements is between 1/50 and ¼ of said pipe diameter D, preferably between 1/30 and ⅙ of said pipe diameter D.

In an embodiment the at least a first metal stiffening element is helicoidal having the same diameter as the inner diameter of the reinforced pipe, or wherein the at least a first metal stiffening element is a helicoidal having the same inner diameter as the outer diameter of the reinforced pipe.

In an embodiment the at least a first metal stiffening element is circular having the same diameter as the inner diameter of the reinforced pipe, or wherein the at least a first metal stiffening element is circular having the same inner diameter as the outer diameter of the reinforced pipe. In an embodiment the at least a first metal stiffening element forms a circle or a circle sector, such as a half circle, or a quart of a circle.

In an embodiment, step b) and d) may be simultaneous. In other words, the bending step is realised by a bending machine, and the welding of the at least a first metal stiffening element is achieved without removing said metal plate or the formed pipe from the bending machine. Step b) and d) may be both achieved in a continuous manner and at the same time or may be intermittent by doing a series of partial step b) and partial step d).

In an embodiment, the method may further comprise the step of welding at least a lower web member to the first metal plate and wherein the at least a first metal stiffening element is placed and welded on top of the at least a lower web member.

In an embodiment, the method may further comprise the step of
e) welding at least a second metal stiffening element on the first metal plate, at an angle to the at least a first metal stiffening element.

In an embodiment, the at least a second metal stiffening element is perpendicular to the at least a first metal stiffening element.

In an embodiment, the welding step e) may comprise welding at least two, at least three, at least four, at least five or at least ten second metal stiffening elements on the first metal plate.

In an embodiment, the welding step e) may comprise welding the at least a metal stiffening elements on the first metal plate after the first metal plate has been bent for at least 400 degrees using a bending machine, forming a full turn, without removing the pipe section from the pipe bending machine. The metal plate is thus supported structurally against collapse during the bending operation by the adjacent part of the finished pipe which has metal stiffening elements installed.

In an embodiment, the method may comprise bending the first metal plate to form at least two turns of a helix.

In an embodiment the reinforced pipe may be a cylinder or a tapered cylinder having a substantially circular or oval base.

In an embodiment the reinforced pipe may be a cylinder or a tapered cylinder having a substantially circular base, the base having an ovalization factor of less 10%, 5%, 2% or 1%. The ovalization factor is here defined as the ratio of the longest diameter of the base divided by the smallest diameter of the base.

In an embodiment, the first metal plate may have a yield strength of at least 200 MPa, at least 250 MPa, at least 300 MPa or at least 400 MPa.

In an embodiment, the first metal plate may be made of steel, a steel alloy, aluminium or an aluminium alloy.

In an embodiment, the at least a first stiffening element may be a plate, a T-beam or a U-beam.

In an embodiment, the at least a first stiffening element may be made of steel, a steel alloy, aluminium or an aluminium alloy.

In an embodiment, the at least a second stiffening element may be made of steel, a steel alloy, aluminium or an aluminium alloy.

In an embodiment, the at least a first stiffening element and the first metal plate are made of the same material.

In an embodiment, the at least a second stiffening element and the first metal plate are made of the same material.

In an embodiment the ratio of the structural capacity of the reinforced pipe to the structural capacity of the first metal plate may be at least 5, preferably at least 10.

In an embodiment, the at least a first stiffening element may be oriented on the first metal plate in a direction so that when the cylinder is formed the at least a first stiffening element forms a ring along the internal periphery of the cylinder.

In an embodiment, at least a second stiffening element is welded in an orthogonal direction to the at least a first stiffening element.

In an embodiment, the method further comprises welding a second metal plate on the at least a first metal stiffening element, wherein the second metal plate is parallel to the first metal plate.

In an embodiment, the second metal plate may be made of steel, a steel alloy, aluminium or an aluminium alloy.

In a second aspect, the application describes to a reinforced pipe, comprising
a first metal pipe, having a thickness t, and a base of diameter D,
at least a first metal stiffening element welded on the inside surface of the reinforced pipe,
   wherein the ratio D/t is over 100.

In an embodiment of the second aspect, the ratio D/t may be between 100 and 1500, preferably between 200 and 800.

In a third aspect, the application describes to a bending machine for making a reinforced pipe, the reinforced pipe comprising a metal pipe, having a thickness t and a base of diameter D, and at least a first metal stiffening element welded on the inside surface along a circumference of the metal pipe, wherein the bending machine comprises an inner roller and two outer rollers, wherein the outer surface of the inner roller or of the outer rollers comprises at least a first groove, to accommodate the at least a first metal stiffening element.

In an embodiment of the third aspect, the ratio D/t is at least 100.

In an embodiment of the third aspect, the at least a first groove has a depth that is at least equal to the height of the at least a first metal stiffening element.

In an embodiment of the third aspect, the at least a first groove may have a depth that is substantially equal to the height of the at least a first metal stiffening element.

In an embodiment, the bending machine may further comprise a means for welding the at least a first metal stiffening element to the metal pipe, such as a welding arm.

In an embodiment, the bending machine may further comprise at least two spacers. Spacers are objects that may be placed on each side of the at least a first stiffening element and between the first metal plate and the inner roller.

In an embodiment, each spacer may comprise a vertical acting spacer roller. A vertical acting spacer roller transmits the pressure of the inner roller to the first metal plate

In an embodiment, each spacer may comprise a lateral acting spacer roller. The lateral acting spacer roller are placed on each side of the at least a first stiffening element, preferably in contact with the at least a first stiffening element, applying a sufficient pressure on the at least a first stiffening element to prevent the at least a first stiffening element from buckling.

In an embodiment, each spacer may comprise two lateral acting spacer rollers.

In an embodiment, each spacer may be freestanding. That is, each spacer need not be attached to another structure.

In an embodiment, the bending machine may further comprise a support roller. A support roller is a roller that supports the formed reinforced pipe, to further help avoid buckling or bending of the helix, pipe or reinforced pipe under its own weight.

In an embodiment, the support roller may be adjustable in height and position. This allows advantageously of modifying the orientation of the longitudinal axis of the reinforced pipe during production of the reinforced pipe/during operation of the bending machine.

In an embodiment, the bending machine may comprise two support rollers.

In an embodiment a series of vertical rollers may be arranged spaced apart along a bending axis on a roller arm member for making a helix pipe in a bending machine. The bending machine may also comprise lateral rollers to support a first metal stiffening element during plastically bending of said metal stiffening element in a bending machine. The series of vertical rollers may be oriented with an axis of rotation substantially perpendicular to a first metal plate feed angle into a bending machine for making a reinforced pipe.

In an embodiment a series of first metal stiffening elements may be welded to a first metal plate at an angle orthogonally to the longitudinal axis of a helix pipe being produced. The metal plate with metal stiffening elements may then be fed into a bending machine during production of said reinforced helix pipe. The bending machine may comprise a helix shaped inner roller which may ensure contact pressure both on first metal plate and on first metal stiffening elements and at the same time may prevent that the first metal stiffening elements clash with the rollers in the bending machine during continuous fabrication of the helix pipe.

In an embodiment, the orientation of the inner and outer rollers may be adjustable relative to the longitudinal axis of the reinforced pipe during operation of the bending machine. This allows advantageously of modifying the orientation of the longitudinal axis of the reinforced pipe during production.

In an embodiment, the first groove of the inner roller of the bending machine may be a helicoidal groove.

In an embodiment, the inner roller may comprise a series of inner rollers and lateral rollers arranged on an inner roller support arm or the outer rollers comprise a series of outer rollers and lateral rollers arranged on an outer roller support arm.

### SHORT DESCRIPTION OF THE DRAWINGS

In the following description this invention will be further explained by way of exemplary embodiments shown in the drawings:

FIG. 1a is a lateral view of an embodiment of a reinforced metal plate.

FIG. 1b is a perspective view of an embodiment of a reinforced metal plate.

FIG. 2a is a lateral view of an embodiment of a reinforced metal plate welded to a second metal plate.

FIG. 2b is a perspective view of an embodiment of a reinforced metal plate welded to a second metal plate.

FIG. 3 is a lateral view of a first metal plate and a first metal stiffening element during bending and the subsequent welding of the first metal stiffening element at an angle β.

FIG. 4 is a perspective view of an embodiment of a reinforced metal plate being bent into a helix and the subsequent welding of the seam.

FIG. 5 is a lateral view of an embodiment of a reinforced metal plate being bent into a helix and the subsequent welding of the seam at an angle α.

FIG. 6 is a perspective view of a first embodiment of the bending machine

FIG. 7 is a perspective view of a second embodiment of the bending machine

FIG. 8 is a perspective view of an embodiment of a first metal plate being bent into a helix and the subsequent welding of the seam.

FIG. 9 is a perspective view of a series of first metal stiffening elements welded to a first metal plate with a first embodiment of spacers

FIG. 10 is a perspective view of a series of first metal stiffening elements welded to a first metal plate with a second embodiment of spacers

FIG. 11 is a front view of a bending machine comprising spacers

FIG. 12 is a perspective view of a series of first metal stiffening elements and a first metal plate going through a bending machine comprising spacers

FIG. 13 is a detail view of a series of first metal stiffening elements and a first metal plate going through a bending machine comprising spacers.

FIG. 14 is a detail view of a series of first metal stiffening elements and a first metal plate going through a bending machine comprising a series of vertical rollers and lateral rollers arranged on an inner roller support arm.

FIG. 15 is a top view of an embodiment with a series of first metal stiffening elements welded longitudinally to a first metal plate which is fed into a bending machine with a feed angle, individual inner rollers arranged on an inner roller support arm with an axis of rotation arranged with an angle δ (delta) to the longitudinal axis of a helix.

FIG. 16 is a top view of an embodiment with a series of first metal stiffening elements welded to a first metal plate 1 at an angle orthogonally to the longitudinal axis of helix, the metal plate is fed into a bending machine, comprising a helix shaped inner roller.

FIG. 17 is a perspective view of a flat plate bent into a helix and welded with other elements to form a reinforced pipe.

### DETAILED DESCRIPTION OF THE INVENTION

In the design of offshore floating wind farms, reducing the weight of the materials is essential to ensure low cost of the energy produced. At the same time, the structures need to keep their strength, in order to be able to tolerate the environmental mechanical stresses.

Therefore, new structures, especially buoyancy tanks, having higher and higher pipe diameter-to-wall-thickness ratios have been developed. For example, it is not unusual to use buoyancy tanks with more than 11 m diameter and only approximately 20 mm wall thickness.

For pipes with relatively high pipe diameter-to-wall-thickness ratios, the conventional production method has been fraught with problems pertaining to buckling of the plates during bending due to the gravity forces acting on the plate. In addition, welding the rings after forming the full pipe is a complex, time consuming and expensive operation.

Therefore, new methods of production have been developed in order to alleviate the problems of the existing methods.

Conventional techniques for fabrication of reinforced pipe sectors or pipes comprise first bending a metal plate, then forming a pipe and thereafter welding metal stiffening elements on the formed cylinder.

Here the skilled person will understand that the method may be used to form pipes such as cylinders, and also tapered cylinders. A tapered cylinder is equivalent to a truncated cone. The method is also adapted to form partial cylinders or partial tapered cylinders.

The skilled person will also understand that any type of welding may be used here, including tack welding before the final welding is carried out at a later stage.

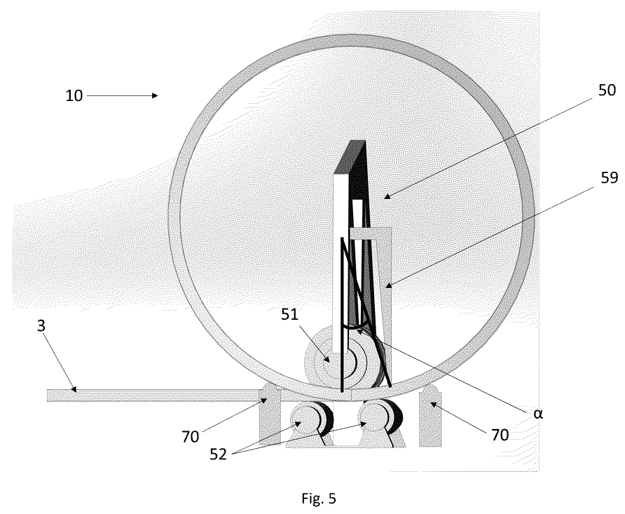

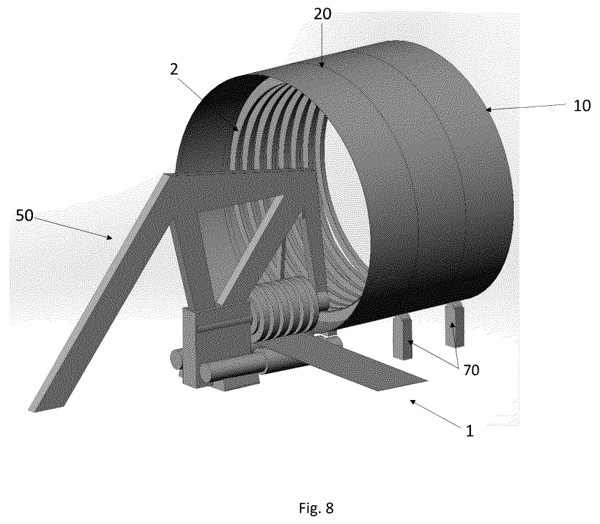

Examples of such a method is for example illustrated in FIGS. 5 and 8. Details and alternatives are illustrated in the other figures. In detail, the inventive method proposes to bend the metal plate 1 along a bending line to form a helix, wherein the pitch of the helix is substantially equal to the width of the plate, and wherein two consecutive turns of the helix are in contact at a seam 20 (or placed in contact); welding the helix 30 along the seam 20 forming a pipe; and welding at least a first metal stiffening element to the pipe, forming a reinforced pipe 10.

Here the skilled person will understand that the at least a stiffening element 2 may typically be any stiffening element traditionally used in the oil and gas industry, especially beams, such as T-beam & U-beam.

Thanks to this inventive method the metal plates 1 will be able to support their own weight during the bending step, and the risk of buckling will be at least reduced or even eliminated.

In addition, this method allows for a continuous process for making a reinforced pipe 10. In particular it allows making a continuous process for making a full reinforced pipe, i.e. a pipe of any desired length.

Here it is possible to both bend the at least a stiffening element 2 together with the first metal plate 1, or to place the at least a stiffening element 2 on the first metal plate 1 after bending it.

It is also possible to both weld the at least a stiffening element 2 to the first metal plate, before (when the at least a stiffening element 2 are present) or after the bending step.

### First Example

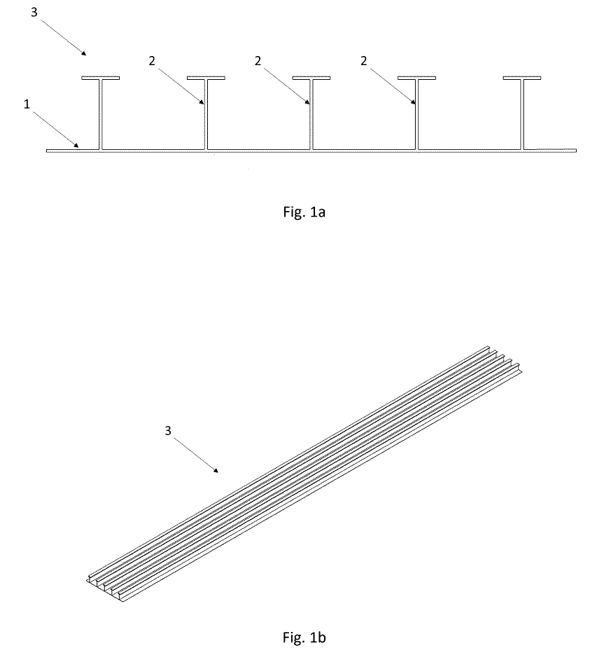

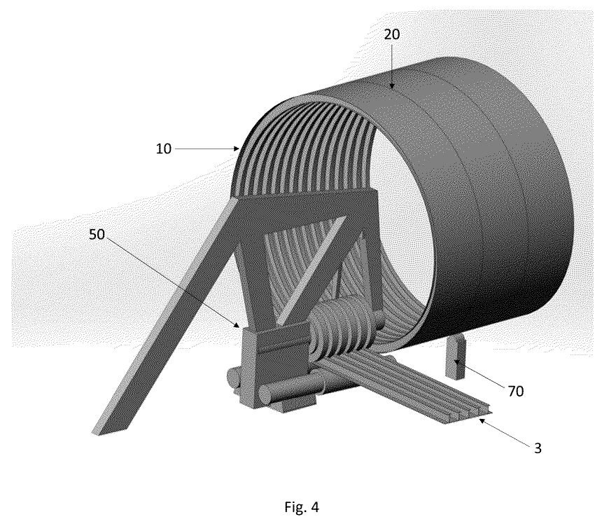

In a first step a series of parallel stiffening elements 2, here T-Beams, were first welded to a flat plate 1, forming a reinforced flat plate 3 as illustrated in FIGS. 1a and 1b. The reinforced flat plate 3 is then run through a bending machine 50 to form a helicoidal stiffened pipe or helix 30, and where the T-Beams also form helices. The seam 20 of the helix 30 is welded, as illustrated in FIGS. 4 and 5, using a welding arm 59, for example at an angle α of 10° from the bending line, i.e. the line on the metal plate along which the metal plate is bent; where the angle α is defined as the angle between a first radius of the helix along which the metal plate is bent starting from the starting point of the bending (or bending line), and a second radius of the helix starting from the welding point. The formed helix is supported by one or more support roller 70.

### Second Example

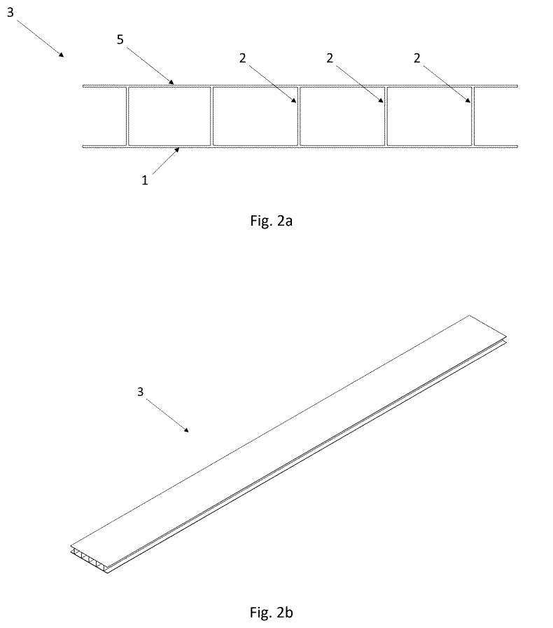

In a first step a series of stiffening elements 2, here shear webs are welded to a first flat aluminum plate 1, and then to a second aluminum plate 5, so that the shear web is comprised between both the first and the second plate 1,5, and so that the first and second aluminum plate 1,5 are parallel. This produces a double flat deck (or double hull deck), as illustrated on FIGS. 2a and 2b. Then the double flat deck is run through a bending machine to form a helicoidal stiffened pipe or helix 30. The seam 20 of the helix 30 is welded, for example using a welding arm, at an angle α of 45° of the bending line.

### Third Example

In a first step a series of parallel first stiffening elements 2, here T-Beams, were welded to a flat plate 1. A series of parallel second stiffening elements 4 orthogonal to the series of first stiffening elements 2, here also T-Beams, were also welded to a flat plate 1, perpendicular to the first stiffening elements 2, forming a reinforced metal plate 3.

The reinforced metal plate 3 is then run through a bending machine 50 to form a helicoidal stiffened pipe or helix 30. The seam 20 of the helix 30 is welded, for example using a welding arm, at an angle α of 45° of the bending line.

### Fourth Example

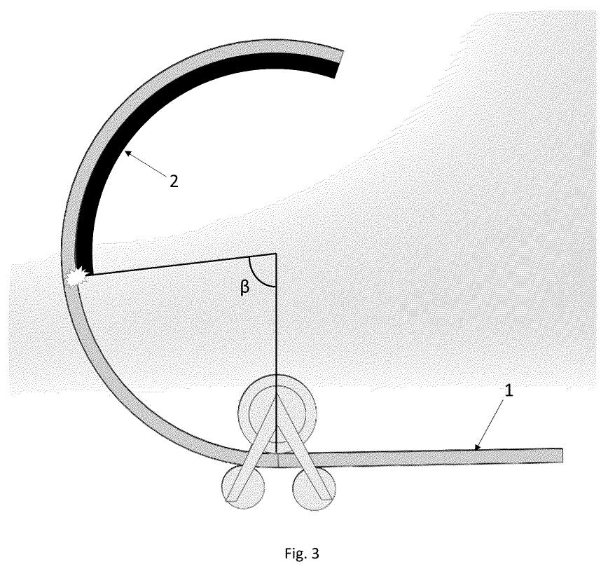

In a fourth example, a series of first stiffening elements 2 are placed on a metal plate 1 (without welding). Then the metal plate 1 and the stiffening elements 2 are run through a bending machine 50 to form a helicoidal stiffened pipe or helix 30. The seam 20 of the helix 30 is welded, or at least tack welded, for example using a welding arm, at an angle α of 10° from the bending line. The series of first stiffening elements 2 are welded shortly after the plate 1 is bended (in other words, the welding takes place at a position not long after, or at, the point of plastically bending the plate), as illustrated in FIG. 3. In other words at a second angle β from the bending line, i.e. the line on the metal plate along which the metal plate is bent; and the angle β is defined between a radius of the circle along which the metal plate is bent starting from the bending line, and a second radius of the circle along which the metal plate is bent starting from the welding point (of the metal stiffener 2).

Here (FIG. 3) at an angle β of approximately 85° of the bending line. For submerged arch welding the optimal welding position is vertical downwards, so the preferred angle α is close to 0 or 360 or 720 degrees etc for welding from the inside of the pipe and 180, 540 degrees etc for welding from the outside of the pipe. In this example the main weld of seam 20 is done from the inside with a α of approximately 10 degrees and the back-welding of seam 20, which is a smaller weld to avoid root defects in the finished weld, is done from the outside at a β of 180 degrees.

In this example the seam is welded first and then the first stiffening elements 2 are welded, i.e. α<β. It is also possible that α=β or that α>β.

### Fifth Example

In a first step a single stiffening element 2, here a U-Beam, was first welded to a flat plate 1, forming a reinforced metal plate 3. The reinforced metal plate is then run through a bending machine 50 to form a helicoidal reinforced pipe. After forming a pipe of suitable dimensions, here for example a pipe of 10 m in diameter, 25 mm thickness, and 40 m in length; the ends are cut so that the pipe has a cylindrical shape.

Here the distance between two first metal stiffening elements 2 may be typically 500-2000 mm.

### Sixth Example

In a first step the metal plate 1 is run through a bending machine 50 to form a helicoidal pipe or helix 30. After the first turn, the seam 20 of the helix 30 is welded, for example using a welding arm, at an angle α of 10° of the bending line. An at least a metal stiffening element 2 is independently manufactured to form a full circle, or substantially a full circle, and positioned inside the welding machine 50 laterally to the side of the rollers 51,52 as shown on FIG. 8. Then, the at least a first metal stiffening element 2 are welded on the first helix 30 after the first metal plate 1 has been bent for at least 360 degrees using a bending machine, i.e. from the second turn, thus forming a reinforced pipe 10. In other words, the formed pipe section is still, at least partially, in the bending machine 50. The bent metal plate 1 is thus structurally supported against collapse during the bending operation by the adjacent part of the finished helicoidal pipe section which has metal stiffening elements installed, as shown in FIG. 8.

### Seventh Example

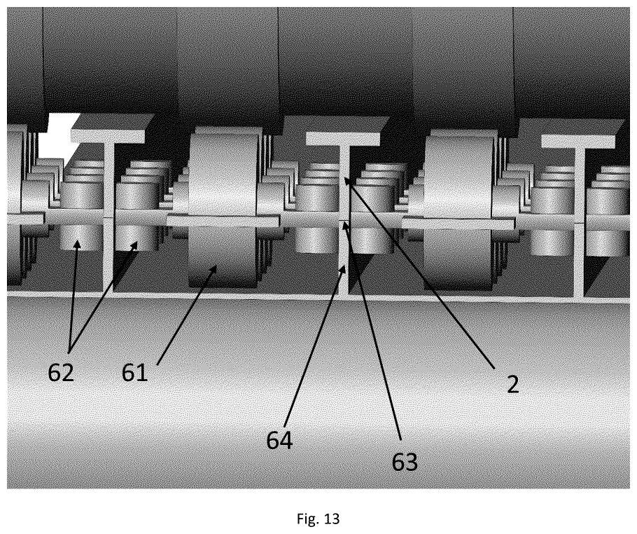

In a seventh example, as illustrated in FIG. 13, a series of lower web members 64 are welded to a metal plate 1, a series of first stiffening elements 2 are placed on top of web members 64 (without welding). Then the metal plate 1 with the web members 64 and the stiffening elements 2 are run through a bending machine 50 and welded together at intersection 63 shortly after the plate 1 with lower web members 64 and stiffening elements 2 are bended (in other words, the welding takes place at a position not long after the point of plastically bending the plate 1 with lower web members 64 and the stiffening elements 2), as illustrated in FIG. 3. In other words at an angle β of the bending line, welding the stiffening elements 2, which in this example has a reduced web height, to the plate 1 comprising the lower part of the lower web membrane 64, after the plastic bending further reduces the combined bending stiffness of the metal plate 1 and the stiffening elements 2 during the bending operation, thus reducing the total required bending forces and the risk of buckling of the stiffening elements during the bending operation as well as reducing the post bending plastic (and permanent) strains in the bended materials. High plastic strain levels could initiate micro cracks in the material and therefore reduce the fatigue strength of the bended materials and should therefore desirably be reduced as much as possible during the fabrication.

### Eighth Example

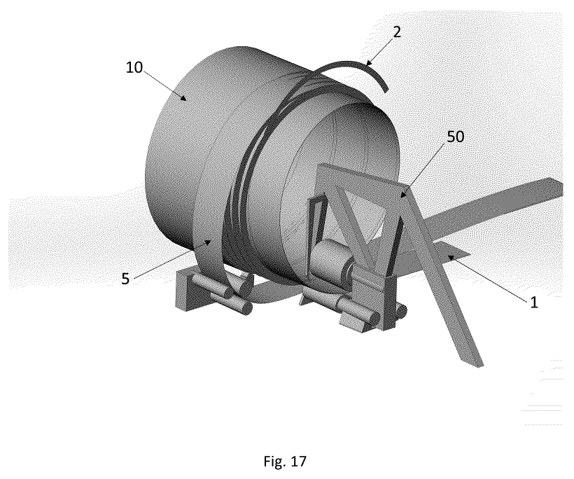

It is now referred to FIG. 17, in an eighth example, the flat plate 1 is run through a bending machine 50 to form a helicoidal pipe or helix 30. Furthermore, at least one stiffening element 2 is independently manufactured or bent to form an arc, a full circle, substantially a full circle or a helix (as shown in FIG. 17), and positioned on an outer surface area of the helicoidal pipe or helix 30. Then, the at least one stiffening element 2 is welded onto the outer surface area of the first helix 30 after the flat plate 1 has been bent for at least 360 degrees using the bending machine 50, i.e. from the second turn, thus forming a reinforced pipe 10.

An advantage of having the stiffening elements 2 on the outer surface area of the formed reinforced pipe 10 is that a second metal plate 5 may be independently bent and more easily welded onto the stiffening elements 2 to produce a double flat deck (or double hull deck), which further reinforces the reinforced pipe 10.

### Ninth Example

In a ninth example, a helicoidal reinforced pipe or helix 30 is prepared as in the eighth example. Thereafter, a second metal plate 5 is bent and then welded to the stiffening elements 2 formed on the outer surface area of the helicoidal reinforced pipe or helix 10 to form a double deck (or double hull deck).

Independently from the examples, when at least two first metal stiffening elements 2 are placed on the first metal plate 1, the at least two first metal stiffening elements 2 are advantageously parallel, and the distance between the at least two first metal stiffening elements 2 is between 1/50 and ¼ of said pipe bending diameter D, preferably between 1/30 and ⅙ of the pipe bending diameter D.

In the same spirit when the at least a first metal stiffening elements 2 is a helix, the pitch of said helix is between 1/50 and ¼ of the pipe bending diameter D, preferably between 1/30 and ⅙ of the pipe bending diameter D.

These sections can then later be mounted together and welded to form a longer cylindrical or tapered cylindrical section.

The person skilled in the art will understand that for the first part and last part of the reinforced pipe 10 the metal plate can be cut prior to the bending operation in order for the pipe ends to come out of the bending machine without a need to cut the metal plates after the bending operation in order to make the cylinder ends orthogonal to the longitudinal axis of the pipe.

### Bending Machine

In one example, the bending machine 50 comprises a pair of outer rollers 52 and an inner roller 51.

The bending machine may further comprise a welding arm 59 as illustrated in FIGS. 4 and 5. The welding arm may be used to weld the helix 30 along the seam 20.

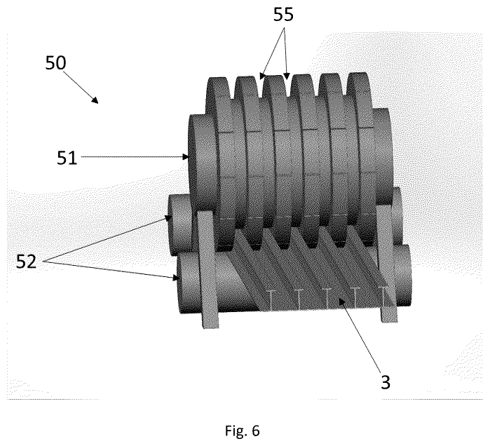

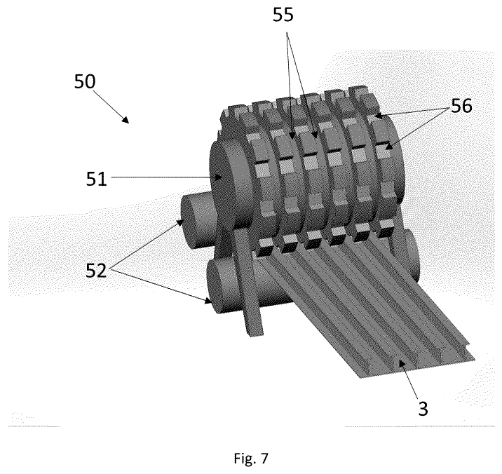

As shown in FIGS. 6 and 7, in this bending machine 50, the inner roller 51 is adapted to bend a metal plate 1 and stiffening elements 2 at the same time and before they are welded together, or the bending machine 50, the inner roller 51 is adapted to bend reinforced bending plate 3, i.e. the metal plate 1 welded to at least a first stiffening element 2.

Instead of being flat, the inner roller 51 is a cylinder (or a tapered cylinder) comprising at least a first groove 55, to accommodate at least a first stiffening element 2. The depth of the at least a first groove 55 is preferably equivalent to the height of the at least a first stiffening element 2. This way the force applied by the inner roller 51 is distributed on both the metal plate 1 and the at least a first stiffening element 2, instead of just on the at least a first stiffening element 2, thereby reducing the risk of buckling in the at least a first stiffening element 2.

The at least a first groove 55 is arranged on a circumference around the inner roller 51.

The inner roller 51 may be a solid piece, or it may alternatively be a cylinder covered by a series of discs.

It is to be understood that when forming a helicoidal stiffened pipe or helix 30 where the stiffening elements 2 are shaped on an outer surface area thereof, such as in the above examples 8, 9 and 10, the at least a first groove 55 must be arranged on the outer rollers 52 instead of the inner roller 51, to accommodate the at least a first stiffening element 2.

As illustrated in FIG. 7, if the reinforced plate 3 comprises at least a first stiffening element 2 and at least a second stiffening element 4, perpendicular to the at least a first stiffening element 2, then the inner cylinder 51 comprises at least a first groove 55, to accommodate at least a first stiffening element 2 and at least a second groove 56, to accommodate at least a second stiffening element 4. The depth of the at least a first groove 55 and of the at least second groove 56 is preferably equivalent to the height of the at least a first stiffening element 2 and of the at least a second stiffening element 4, respectively. This way the force applied by the inner roller 51 is distributed on both the metal plate 1, the at least a first stiffening element 2 and the at least a second stiffening element 4, instead of just on the at least a first stiffening element 2 and/or the at least a second stiffening element 4, thereby reducing the risk of buckling in the at least a first stiffening element 2 and/or the at least a second stiffening element 4.

The at least a first groove 55 is arranged on a circumference around the inner cylinder (or of the tapered inner cylinder). The at least a second groove 56 is arranged longitudinally along the outer surface of the inner roller 51.

The bending machine 50 may be advantageously mounted so that the central axis of the inner roller is orthogonal or parallel to the axis of gravity. In this example the metal plate 1 will wind up around inner roller 51 during the production of the helix. It will therefore be necessary to lift the outer roller 51 in order for the helix 30 to be moved along the longitudinal axis of the helix 30. Therefore, for this embodiment, the helix reinforced pipe production needs to be done in steps.

It is to be understood that when forming a helicoidal stiffened pipe or helix 30 where the stiffening elements 2 are shaped on an outer surface area thereof, such as in the above examples 8, 9 and 10, the at least a first groove 55 and the at least a second groove 56 must be arranged on the outer rollers 52 instead of the inner roller 51, to accommodate the at least a first stiffening element 2 and the at least a second stiffening element 4.

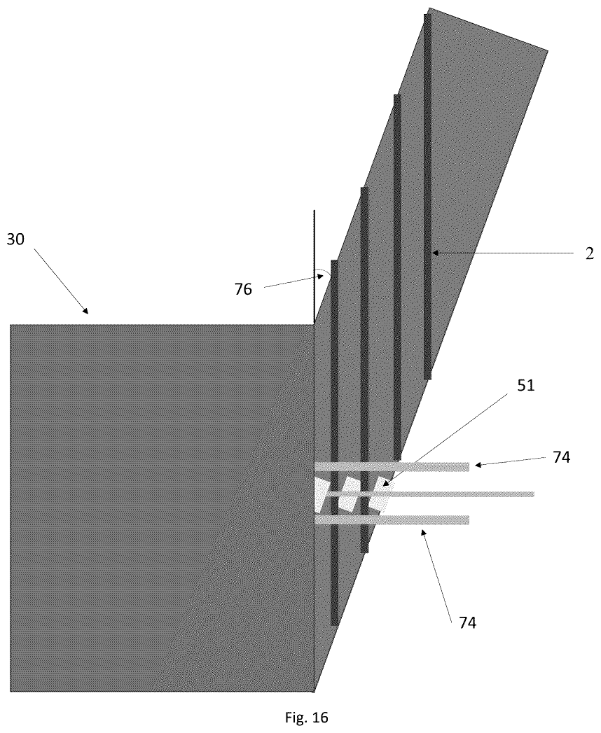

In a second example of bending machine 50 the disadvantage of producing the helix reinforced pipe 30 in steps is avoided. In this example the bending machine is arranged in the same way as described above, but with the difference that the groove on the inner roller 51, is a helicoidal groove so that the metal plate 1 will not wind up around inner roller 51 during continuous production of the helix. Here the helicoidal groove is arranged with a pitch that is adapted to the diameter of the roller, the distance between each stiffening elements 2 and the feed angle 76. In this way the stiffening elements 2 will not clash with the helicoidal groove during continuous fabrication of the helix pipe 30. By arranging the stiffening elements 2 orthogonally to the longitudinal axis of the helix pipe 30 being produced, as shown on FIG. 16, and let the distance between each stiffening elements 2 be equal to the circumference of the helix pipe 30 divided by a positive integer, then it is possible to produce a reinforced pipe 10 in a spiral welding method and still have orthogonally individual stiffening elements 2 spaced apart inside the pipe. I.e. in this example the stiffening elements 2 will not be spiral shaped but closed circles spaced apart orthogonally relative to the longitudinal axis of the helix pipe 30.

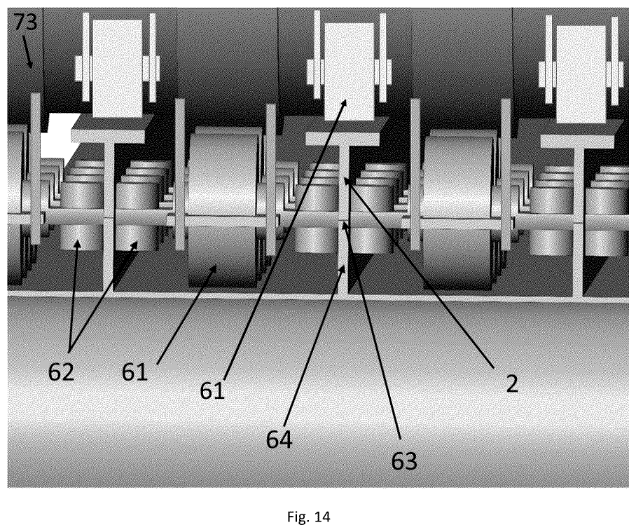

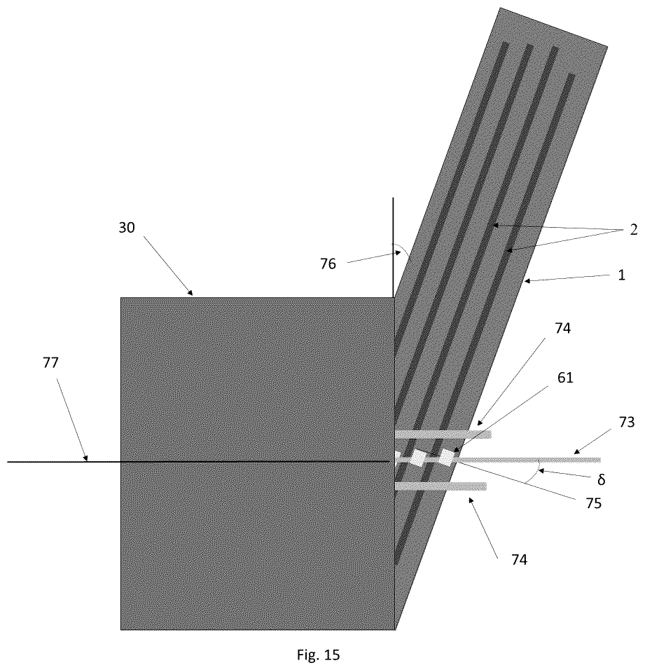

In a third example of bending machine 50 the bending machine is arranged in the same way as described in the first example of bending machine 50 above but with the inner roller 51 comprising a series of inner rollers 61 and lateral rollers 62 arranged on an inner roller support arm 73 as shown in FIG. 14. As shown in FIG. 15 a series of first metal stiffening elements 2 welded longitudinally to a first metal plate 1 is fed into a bending machine 50 with a feed angle 76. Individual inner rollers 61 are arranged on inner roller support arm 73 spaced apart along a bending line substantially parallel with longitudinal axis 77 of helix 30. Said individual inner rollers 61 are further arranged on inner roller support arm 73 with a substantially horizontal axis of rotation arranged with an angle δ (delta) to the longitudinal axis 77 of a helix 30. The rotation angle δ (delta) can be arranged self-adjustable (similar to the wheels of a supermarket cart) to allow the metal plate 1 to be freely fed into the bending machine forming the helix 30 without resisting the forward moving motion along axis 77 during the production of said helix 30. As shown on FIG. 14 lateral spacers comprising lateral rollers 62 are arranged on inner rollers 61 to support the at least a first metal stiffening element 2 during plastic bending of said first metal stiffening element 2. In order to ensure stability of the rollers at least 2 lateral rollers 62 are arranged on each side of each of inner rollers 61.

It is to be understood that when forming a helicoidal stiffened pipe or helix 30 where the stiffening elements 2 are shaped on an outer surface area thereof, such as in the above examples 8, 9 and 10, it is the outer rollers 52 that comprise a series of outer rollers and lateral rollers arranged on an outer roller support arm.

When manufacturing a helix pipe according to this invention the diameter D of the pipe may change slightly (little by little) during the proposed manufacturing process if the pipe is long. It could also be desirable to transition from a straight section to a coned section during manufacturing of the pipe. In order to control the pipe diameter D, if the pipe is manufactured in the horizontal direction as shown on the figures, the central longitudinal axis of both the inner and outer rollers is adjusted relative to the longitudinal axis of the pipe. By relatively tilting the rollers 51, 52, about a horizontal axis orthogonally positioned to the longitudinal axis of the pipe, so that the far end of the rollers (the end pointing away from the cylinder being manufactured) is raised (and thereby getting closer to the central axis of the pipe 10, the pipe diameter D will be reduced in the way of coning the pipe inwards as the bending operation continues. To increase the pipe diameter D the opposite tilting of the rollers 51,52 is done. Since the important feature to control the diameter D is the position of the central axis between said rollers 51,52 relative to the longitudinal axis of the pipe 10 this relative adjustment can be carried out either by tilting the inner/outer rollers or by tilting the pipe 10 by adjusting the height of the support rollers 70 of the pipe. Adjusting the support rollers of the pipe can be done by jacking these supports up or down. Jacking up in order to tilt the pipe will start to decrease the diameter D of the pipe as it is being rolled and welded to the rest of the pipe. Jacking down in order to tilt the pipe will increase the diameter D as it is being rolled and welded to the rest of the pipe.

When adjusting the pipe diameter D the adjustment of the pitch of each helix also has to be done by adjusting the feed angle 76 of the metal plate 1 entering the bending machine 50. Hence the diameter D will depend on the pitch of the spiral and the feed angle.

When bending the metal plates 1 with stiffening elements 2 there is a risk that the stiffening elements may buckle. One way to reduce the buckling risk is to increase the width between the 2 outer rollers 52 in order to increase the efficient bending arm, thus reducing the required roller 51,52 forces needed to plastically bend the plate 1 with stiffening elements 2.

In other words, to reduce the force applied to the plate 1 with welded stiffening elements 2, the space between the outer rollers 52 of the bending machine 50 may be increased.

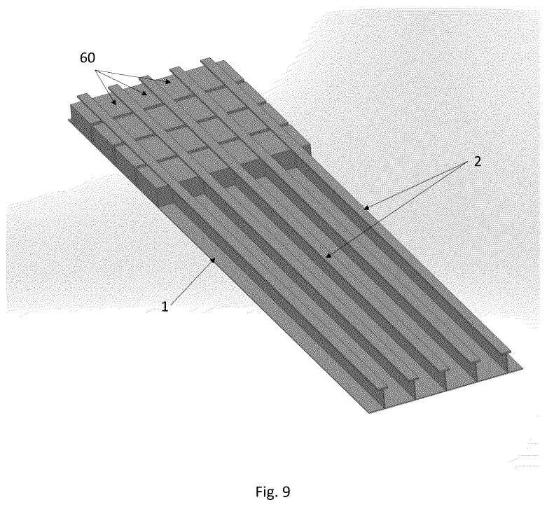

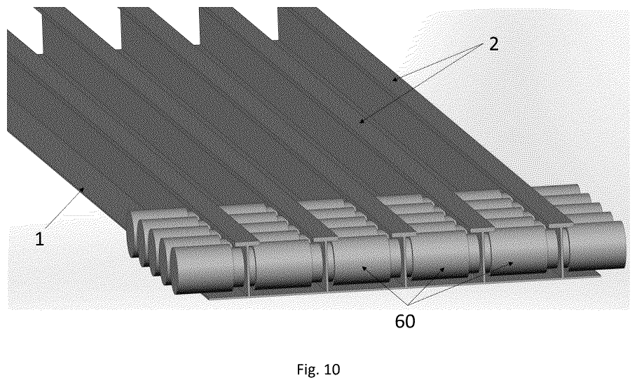

Another alternative to reduce the risk of buckling is using at least two spacers 60. Spacers are objects that may be placed on each side of the at least a first stiffening element 2 and between the first metal plate 1 and the inner roller 51, as illustrated on FIGS. 9 and 10. Preferably these at least two spacers 60 cover the width of the first metal plate 1, along the bending line, and even more preferably on each side of the bending line, wherever the inner roller will be in contact with the first metal plate and the at least a first stiffening element.

There may be multiple spacers of different width depending on the number of first stiffening elements 2, and their placement on the first metal plate 1. In other words, the width of a spacer 60 is the distance between two stiffening elements 2, or between a stiffening element 2 and the side of the first metal plate 1.

Preferably, it is intended that each of the at least a first stiffening element 2 is comprised between at least 2 spacers, so that the spacers will prevent buckling during the bending step c).

The at least two spacers 60 may be any suitable shape that complements the shape of the at least a first stiffening element 2, for example so that the cross section of the shape of the at least two spacers 60 and the shape of a first stiffening element 2 may be a substantially rectangular, as shown in FIGS. 9 and 10, of substantially the same width as the first metal plate 1 and of substantially the same height as the at least a first stiffening element 2.

In the case of the at least a first stiffening element 2 being a T-Beam or a U-Beam, the at least two spacers 60 may be cuboids.

The at least two spacers 60 may be freestanding. That is, they are not necessarily attached to a support structure or the like.

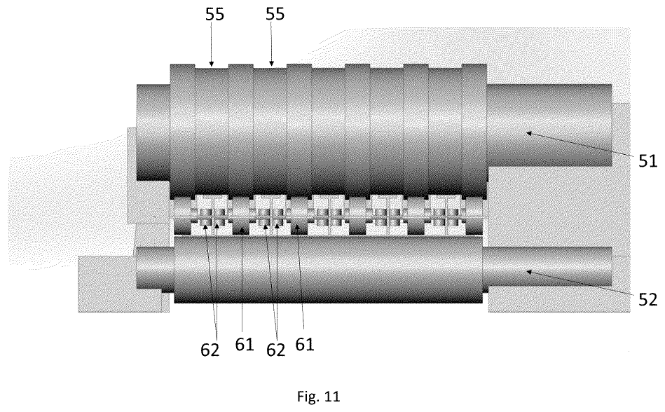

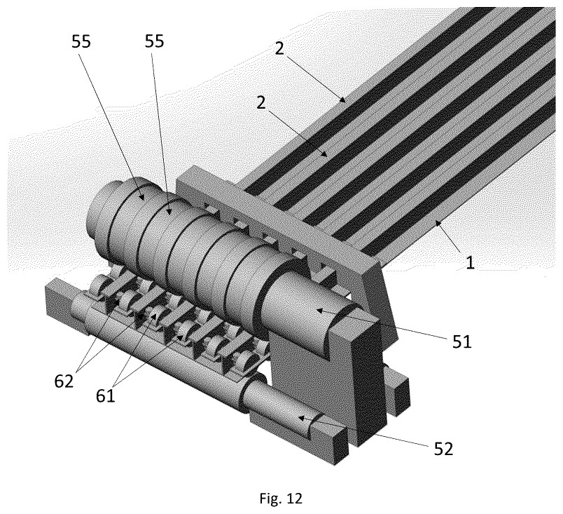

Preferably the at least two spacers 60 may comprise vertical acting spacer rollers 61 that transmit the pressure of the inner roller 51 to the first metal plate 1, as illustrated in FIGS. 11 and 12.

Preferably the at least two spacers 60 may further comprise lateral acting spacer roller 62 to keep the at least a first stiffening element 2 from buckling.

Each roller 61,62 may be free-rolling or may have a motor driving them.

It is understood that separate drive rollers as used in known technology for spiral welding of pipes may be used with this invention, as well as any other features known to the person skilled in the art of spiral welding of pipes.

In the case of the at least a first stiffening element 2 being T-beams, the at least two spacers 60, should be designed to avoid the buckling of all the part of the T-beams, i.e. both the shear web and the flange, as in the examples above using roller(s) (FIG. 10, 11 or 12) or cuboids (FIG. 9).

It is to be understood that when forming a helicoidal stiffened pipe or helix 30 where the stiffening elements 2 are shaped on an outer surface area thereof, such as in the above examples 8, 9 and 10, the at least two spacers 60 are preferably placed on each side of the at least a first stiffening element 2 and between the first metal plate 1 and the outer rollers 52.

A bending machine 50 is not always able to apply a bending moment to the end of the item to be bent and it is therefore not possible to permanently and plastically bend the very ends. Due to this difficulty, the end parts of the metal plates 1 are often not bent when bending the plates 1. Usually, the non-bent end portions of the plate 1 are cut away before being welded together to form a pipe, such as a cylinder.

To further improve the method one or both end portions of the metal plate 1 may be bended in a first step, before placing the stiffening element 2 on the plate. In addition, the at least a stiffening element 2 may be shaped or cut at one or both end portions so that the at least a stiffening element 2 may be easily placed on the plate 1 (with bended one or both end portions).

Thus, the metal plate 1 has ski tip like end portions which do not need to be plastically bent to become part of the final circular or substantially circular shape of the produced pipe section, as plate 1 and stiffener elements 2 and their respective end sections will have a substantially identical curvature after going through the bending machine thus forming a substantially circular section.

1. A method of manufacture for a reinforced pipe (10) including the steps of,
a) providing a first metal plate (1), having a thickness t;
b) bending the first metal plate (1) along a bending line to form a helix (30),
wherein the pitch of the helix (30) is substantially equal to the width of the plate; and
wherein two consecutive turns of the helix (30) are in contact at a seam (20);
c) welding the helix along the seam (20) forming a pipe; and
d) welding at least a first metal stiffening element (2) to the pipe, forming a reinforced pipe (10).

2. A method according to claim 1, wherein the reinforced pipe (10) has a diameter D, and the ratio D/t is comprised between 100 and 1500, preferably between 200 and 800.

3. A method according to claim 1, wherein in step c), the helix (30) is welded along the seam (20) within 400° of the bending line.

4. A method according to claim 3, wherein in step d), the at least a first metal stiffening element (2) is welded within 400° of the bending line.

5. A method according to claim 1, wherein the at least a first metal stiffening element (2) is helicoidal having the same outer diameter as the inner diameter of the reinforced pipe (10), or wherein the at least a first metal stiffening element (2) is a helicoidal having the same inner diameter as the outer diameter of the reinforced pipe (10).

6. A method according to claim 1, wherein the at least a first metal stiffening element (2) is circular having the same outer diameter as the inner diameter of the reinforced pipe (10), or wherein the at least a first metal stiffening element (2) is circular having the same inner diameter as the outer diameter of the reinforced pipe (10).

7. A method according to claim 1, wherein step d) comprises welding at least two first metal stiffening elements (2) on the first metal plate (1).

8. A method according to claim 7, wherein the at least two first metal stiffening elements (2) are parallel to each other.

9. A method according to claim 8, wherein the distance between the at least two first metal stiffening elements (2) is between 1/50 and ¼ of said pipe diameter, preferably between 1/30 and ⅙ of the pipe bending diameter D.

10. A method according to claim 1, wherein t is 30 mm or less.

11. A method according to claim 1, further comprising the step of
e) welding at least a second metal stiffening element (4) on the first metal plate (1), at an angle to the at least a first metal stiffening element (2).

12. A method according to claim 11, wherein the at least a second metal stiffening element (4) is perpendicular to the at least a first metal stiffening element (2).

13. A method according to claim 1, wherein the at least a first metal stiffening element (1) is a T-beam or a U-beam.

14. A method according to claim 1, comprising bending the first metal plate (1) to form at least two turns of the helix (30).

15. A method according to claim 1, wherein step b and d are simultaneous.

16. A method according to claim 1, further comprising the step of welding at least a lower web member (64) to the first metal plate (1) and wherein the at least a first metal stiffening element (2) is placed on top of the at least a lower web member (64) and welded together after said at least lower web member (64) and at least a first metal stiffening element (2) have been bent together with the first metal plate (1).

17. A method according to claim 1, further comprising the step of
providing a pre-manufactured at least a first metal stiffening element (2) forming full circle or substantially a full circle, and
positioning the at least a first metal stiffening element (2) inside or outside the helix formed by the bent metal plate after at least a full turn of the helix is bent, but before the complete first metal plate is bent.

18. A method according to claim 4, wherein step d) comprises welding at least tow first metal stiffening elements (2) on the first metal place (1).

19. A method according to claim 7, wherein step b and d are simultaneous.

20. A method according to claim 8, wherein step b and d are simultaneous.
